(19) United States
(12) Patent Application Publication
(10) Pub. No.: US 2026/0318273 A1
(43) Pub. Date: Oct. 15, 2026

(54) WAVE ENERGY APPARATUS

(71) Applicant: CHECKMATE LIMITED, Cranbrook, Kent (GB)

(72) Inventor: Mark PRENTICE, Cranbrook (GB)

(73) Assignee: CHECKMATE LIMITED, Cranbrook, Kent (GB)

(21) Appl. No.: 19/106,560

(22) PCT Filed: Aug. 31, 2023
(86) PCT No.: PCT/GB2023/052248

§ 371 Date: Feb. 25, 2025

(30) Foreign Application Priority Data
Aug. 31, 2022 (GB) 2212652.8

(51) Int. Cl. F03B 13/14

(52) U.S. Cl. CPC F03B 13/14

(57) ABSTRACT

A wave energy apparatus for extracting energy from waves generated by a body of water, the apparatus including an elongate flexible tubular body, which defines a channel therein having a longitudinal axis, and a plurality of resiliently deformable elements disposed along the tubular body; wherein the elongate flexible tubular body is inextensible in a radial direction; the elongate flexible tube is open at each end; each resiliently deformable element is axially spaced from the adjacent resiliently deformable elements; each resiliently deformable element is secured to the tubular body at two or more anchor portions, wherein the anchor portions for each resiliently deformable element are circumferentially spaced from each other; each of the resiliently deformable elements has a non-extended configuration in which the respective anchor portions of the tubular body are spaced from the longitudinal axis of the channel by a first spacing, and an extended configuration in which the anchor portions of the tubular body are displaced radially outwards and are spaced from the longitudinal axis of the channel by a second spacing, wherein the second spacing is greater than the first spacing; and wherein the cross-sectional area of the tubular body when the resiliently deformable elements are in their extended configuration is greater than the cross-sectional area of the tubular body when the resiliently deformable elements are in their non-extended configuration.

The present invention relates to an apparatus for extracting energy from waves formed in a body of water.

Wave energy apparatus are known for example from WO2012/095832 which discloses a flexible membrane disposed within a non-distensible but flexible tube. The skilled person will note that the apparatus disclosed in WO2012/095832 requires a flexible, expandable membrane to be secured to a flexible, but non-distensible tube. This creates associated engineering challenges.

When a wave enters the apparatus described in WO2012/095832, a bulge wave forms within the flexible tube, which travels longitudinally along the tube. Such bulge waves travelling through distensible tubes represent an efficient method of converting energy stored in waves into a more usable form of energy.

It is desired to provide an alternative wave energy apparatus which avoids the need to secure a flexible membrane along a lengthwise portion of the non-distensible tube.

According to a first aspect of the invention, there is provided a wave energy apparatus for extracting energy from waves generated by a body of water, the apparatus including an elongate flexible tubular body, which defines a channel therein having a longitudinal axis, and a plurality of resiliently deformable elements disposed along the tubular body; wherein the elongate flexible tubular body is substantially inextensible in a radial direction; the elongate flexible tube is open at each end; each resiliently deformable element is axially spaced from the adjacent resiliently deformable elements; each resiliently deformable element is secured to the tubular body at two or more anchor portions, wherein the anchor portions are circumferentially spaced from each other; each of the resiliently deformable elements has a non-extended configuration in which the anchor portions of the tubular body are spaced from the longitudinal axis of the channel by a first spacing, and an extended configuration in which the anchor portions of the tubular body are displaced radially outwards and are spaced from the longitudinal axis of the channel by a second spacing, wherein the second spacing is greater than the first spacing; and wherein the cross-sectional area of the tubular body when the resiliently deformable elements are in their extended configuration is greater than the cross-sectional area of the tubular body when the resiliently deformable elements are in their non-extended configuration.

It will be appreciated that the resiliently deformable elements urge the anchor portions towards the longitudinal axis of the channel and deform the circumferential shape of the tubular body when they are in their non-extended configuration. Typically, when the resiliently deformable elements are in their non-extended configuration, the tubular body defines a cross-sectional shape having two or more lobes. When one of the open ends of the apparatus encounters a wave and a bulge wave is generated within the tubular body, the resiliently deformable elements are stretched/expanded/extended, which causes the anchor portions to be displaced radially outwards from the longitudinal axis. This in turn causes the circumferential shape of the tubular body to move towards a circular configuration and increases the cross-sectional area of the channel defined by the tubular body. Once the bulge wave has passed, the restorative forces exerted by the resiliently deformable elements urge the anchor portions back to their rest position/configuration, i.e. the first spacing from the longitudinal axis.

Thus, as a wave passes through the tubular body, the cross sectional area of the tubular body increases and decreases. Energy can be captured from this change in cross sectional area.

It will be appreciated that the term “axially spaced” refers to adjacent resiliently deformable elements being spaced from each other in a direction which is along or parallel to the longitudinal axis of the tubular body. Similarly, the term “circumferentially spaced” refers to anchor portions for each resiliently deformable element being defined by the tubular body and being radially or angularly spaced from each other around the circumference of the tubular body. Thus, the anchor portions are suitably defined by the tubular body.

The use of a plurality of discrete resiliently deformable elements, which are secured to the tubular body at respective anchor points, makes it is easier to manufacture the apparatus.

Furthermore, if one of the resiliently deformable elements fails, the apparatus will continue to function. It is also easier to repair a damaged resiliently deformable element, for example during a service of the apparatus.

As noted above, the tubular body is substantially inextensible in a radial direction. In the context of the present invention, the term “substantially inextensible” means that the diameter of the tubular body is capable of increasing by no more than 10%, suitably no more than 5%, 4%, 3%, 2% or 1%. This means that the cross-sectional area of the tubular body has a maximum value. It also means that each of the resiliently deformable elements have a maximum extension (i.e. the second spacing has a maximum value). This prevents the resiliently deformable elements being overstretched. It will be appreciated that the above values represent the strain in the material which forms the tubular body under normal working conditions.

Suitably, the apparatus is located within a body of water and arranged such that a bulge wave is generated within the tubular body as a wave passes over the tubular body. This bulge wave urges the resiliently deformable elements into their extended configurations as the bulge wave passes each respective resiliently deformable element.

The flexible tubular body may be formed from a reinforced and/or coated fabric, such as for example a reinforced rubber coated fabric. Such structures are flexible, are substantially inextensible in a radial direction and have an established history of use within aquatic or marine environments, such as at sea.

Although the tubular bodies are substantially inextensible in a radial direction, they may be extensible to some degree in an axial direction.

In an embodiment of the invention, the anchor portions for each resiliently deformable element are equally spaced around the circumference of the tubular body. Thus, the angular spacing(s) between the anchor portions is/are substantially equal. This results in the forces exerted on the tubular body by the resiliently deformable elements being evenly distributed about the circumference of the tubular body.

Suitably, each resiliently deformable element is rotationally offset about the longitudinal axis from adjacent resiliently deformable elements.

Each resiliently deformable element may be connected to the tubular body via 2 or more anchor portions defined about the circumference of the tubular body. For example, each resiliently deformable element may be connected to the tubular body via 2, 3, 4, 5 or 6 anchor portions, which secure the resiliently deformable element to the tubular body.

For example, in embodiments in which the tubular body defines two anchor portions for each of the resiliently deformable elements, these are suitably arranged to be opposite to each other. In other words, they have an angular spacing of 180°. In embodiments in which the tubular body defines three anchor portions for each resiliently deformable element, these may have an angular spacing between neighbouring anchor portions of 120°. In embodiments in which the tubular body defines four anchor portions for each of the resiliently deformable elements, these may have an angular spacing between neighbouring anchor portions of 90°. In embodiments in which the tubular body defines five anchor portions for each of the resiliently deformable elements, these may have an angular spacing between neighbouring anchor portions of 72°. In embodiments in which the tubular body defines six anchor portions for each resiliently deformable element, these may have an angular spacing between neighbouring anchor portions of 60°.

Each resiliently deformable element may be a single, unitary element. Such elements may be in the form of an elastic cord or band. Alternatively, each resiliently deformable element may be formed from two or more resiliently deformable (e.g., elastic) cords or bands. In embodiments in which each resiliently deformable element comprises two elastic cords or bands, for example, each cord or band may be secured to the tubular body at 2 or 3 respective anchor portions. In embodiments in which each resiliently deformable element comprises three elastic cords or bands, for example, each cord or band may be secured to the tubular body at two respective anchor portions. Thus, each resiliently deformable element may comprise 1, 2 or 3 resiliently deformable cords or bands, suitably 1 or 2 cords or bands.

In embodiments in which each resiliently deformable element comprises 2 or 3 cords or bands, the cords/bands may be arranged to be parallel to each other and spaced from each other laterally with respect to the longitudinal axis or they may be rotated relative to each other about the longitudinal axis such that they overlap with each other about a central portion. For example, two cords/bands may be rotated relative to each other about the longitudinal axis by 90° such that they are arranged in a cruciform configuration.

In one embodiment, each resiliently deformable element comprises one or more elastic cylindrical cords. For example, each resiliently deformable element may comprise one, two or three elastic cylindrical cords. The or each cylindrical cord may be a solid cylindrical cord or may be a hollow tubular cord. The or each elastic cord is suitably formed from a rubber material, which may be a naturally-occurring rubber material, a synthetic rubber material or a mixture thereof. The opposed ends of the cylindrical cords may be flared to provide a greater surface area via which the ends of the cords may be secured to an inwardly-facing surface of the tubular body. For example, the flared ends of the cords may be adhered or welded to the respective anchor portions of the tubular body. In such embodiments, each anchor portion defined by the tubular body may comprise a metal or polymeric fixing element to which a respect end of a cord is secured.

In an alternative embodiment, each resiliently deformable element may include one or more continuous loops or bands of elastic material (e.g., a rubber material). In such embodiments, each anchor portion defined by the tubular body may comprise an anchor element, wherein the anchor elements are coupled to the tubular body and the or each continuous loop of elastic material is coupled to a respective number of the anchor elements. For example, each continuous loop of elastic material may be secured to the tubular body via a respective pair of anchor elements. Thus, the anchor elements function to secure the elastic material to the tube.

The anchor elements avoid the need to secure the resiliently deformable elements directly to the tubular body. For example, the anchor elements may each define an engagement portion which engages a portion of the respective continuous loop of elastic material. Such an engagement portion may comprise a cylindrical element or a saddle-shaped element about which a portion of the continuous loop of elastic material may be coupled. Furthermore, each anchor element may include a coupling portion via which the anchor element is coupled to the tubular body.

In an embodiment of the invention, each continuous loop of elastic material has a substantially elliptical or circular cross section. Such loops of elastic material are known and are relatively straightforward to prepare. The loop may be formed from a single cord of elastic material or it may be formed from a plurality of separate cords of elastic material which are bound together to form the continuous loop. For example, each loop may comprise a plurality of elastic cords which are bound together via a binding material. In this way, if one or more of the individual elastic cords fail, the loop will still continue to function as desired.

Alternatively, each continuous loop of elastic material may comprise a unitary band of elastic material which comprises two or more anchor regions wherein the band has a first cross-sectional shape, and the anchor regions are connected by connecting regions wherein the band has a second cross-sectional shape, and the first and second cross-sectional shapes are different. For example, the band may include anchor regions having a substantially rectangular cross-sectional shape and connecting regions which have substantially elliptical or circular cross-sectional shapes.

In a further embodiment of the invention, the apparatus further includes one or more buoyancy members. The or each buoyancy member suitably maintains the tubular body at a desired location and or orientation relative to a body of water. For example, the or each buoyancy member may be secured to or located in an upper portion of the tubular body. In this way, the upper part of the tubular body is maintained at or towards the surface of the water in use, with the remainder of the tubular body being maintained below the surface of the water. In this way, the energy from the waves formed in the body of water is most efficiently captured by the apparatus.

The buoyancy member may be a buoyancy material, such as a flotation foam.

Suitably, the apparatus further includes an energy converter which converts the energy extracted from each wave by the apparatus into electrical energy. Any suitable energy converter (also known as a “power take off” unit or “PTO”) may be used with the invention. Many such energy converters are known. For example, a fluid may be compressed or pressurised by the increase in the cross-sectional area of the elongate flexible tubular body, and the compressed/pressurised fluid may then drive an impeller or turbine which forms part of the energy converter. Thus, the energy converter may include a turbine or an impeller which is driven by a pressurised or compressed fluid. Suitably, the energy converter includes a fluid source, a turbine and conduits which direct the fluid to the turbine and away from the turbine. For example, the elongate flexible tubular body may be located within an outer, non-distensible tube, wherein the outer tube defines one or more fluid channels between an outer tubular body and the elongate flexible tubular body located within the outer tube; and the or each fluid channel is compressed when the cross-sectional area of inner elongate tubular body increases. The compression of the or each fluid channel may compress or pressurise the fluid disposed within the or each fluid channel and the compressed/pressurised fluid may drive an impeller or a turbine, which forms part of the energy converter. The energy converter suitably converts the wave energy into electrical energy.

Alternatively, the fluid may be compressed or pressurised by the contraction of the flexible tube (i.e. the decrease in the cross-sectional area) and the compressed/pressurised fluid may be directed through a turbine, such that the compressed/pressurised fluid drives the turbine.

The skilled person will appreciate that the features described and defined in connection with the aspects of the invention and the embodiments thereof may be combined in any combination, regardless of whether the specific combination is expressly mentioned herein. Thus, all such combinations are considered to be made available to the skilled person.

Embodiments of the invention will now be described, by way of example only, with reference to the accompanying drawings in which:

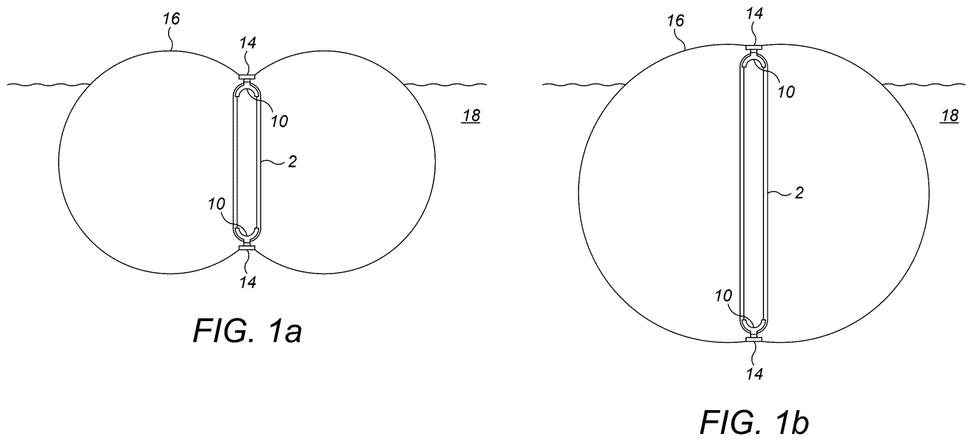

FIGS. 1a and 1b show a cross section through a wave energy apparatus according to a first embodiment of the invention, in which FIG. 1a shows the elasticated band in its non-extended configuration and FIG. 1b shows the elasticated band in its extended configuration;

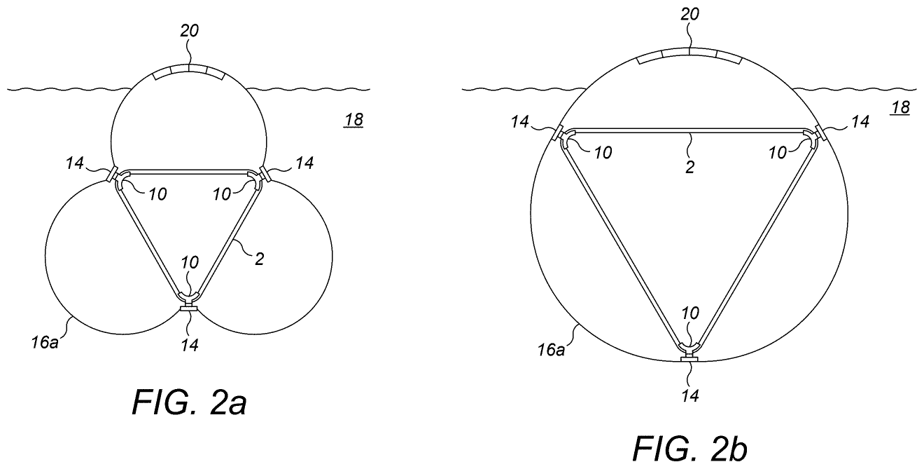

FIGS. 2a and 2b show a cross section through a wave energy apparatus according to a second embodiment of the invention, in which FIG. 2a shows the elasticated band in its non-extended configuration and FIG. 2b shows the elasticated band in its extended configuration;

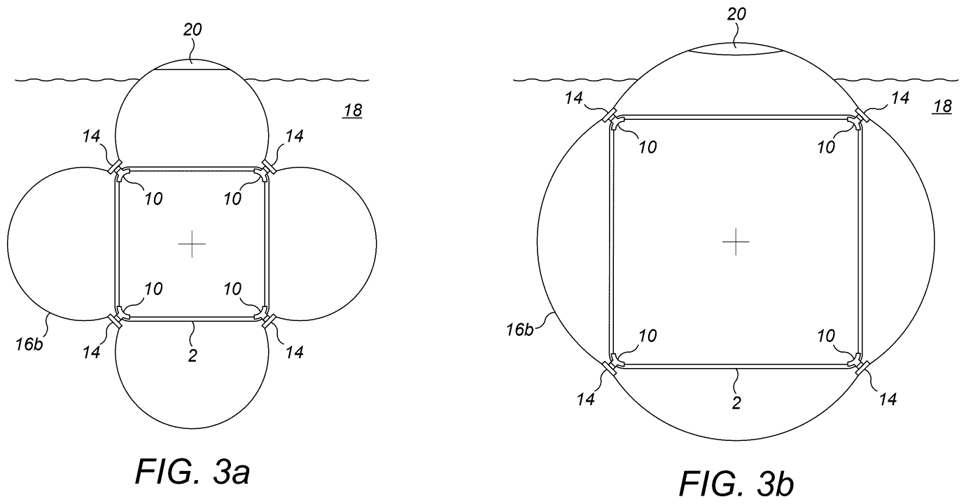

FIGS. 3a and 3b show a cross section through a wave energy apparatus according to a third embodiment of the invention, in which FIG. 3a shows the elasticated band in its non-extended configuration and FIG. 3b shows the elasticated band in its extended configuration;

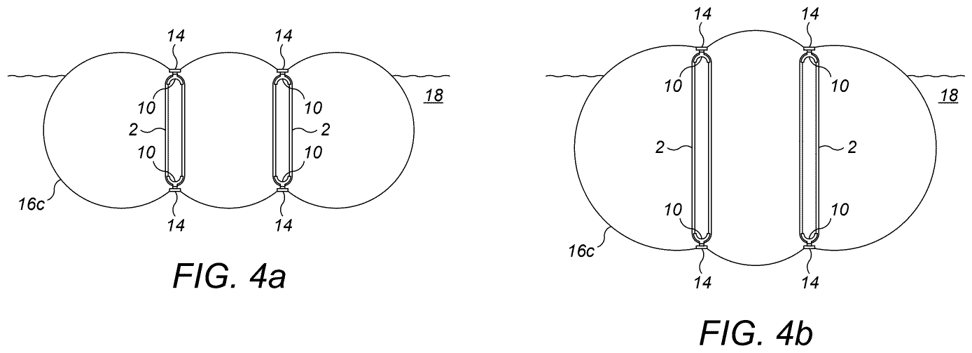

FIGS. 4a and 4b show a cross section through a wave energy apparatus according to a fourth embodiment of the invention, in which FIG. 4a shows the elasticated bands in their non-extended configuration and FIG. 4b shows the elasticated bands in their extended configuration;

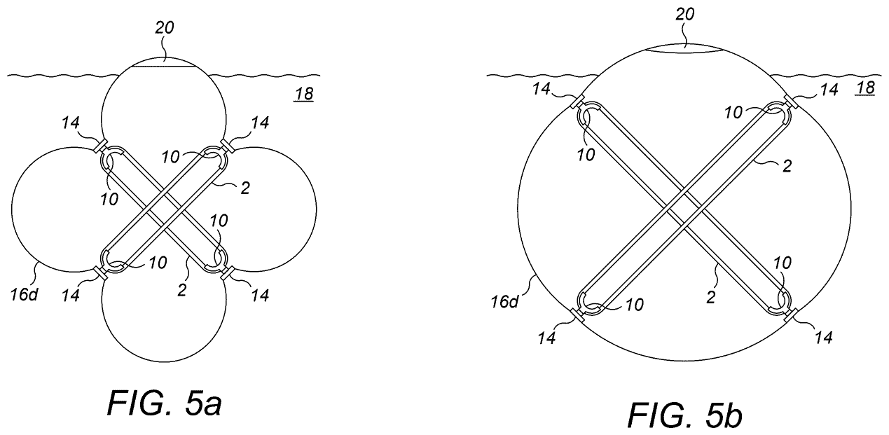

FIGS. 5a and 5b show a cross section through a wave energy apparatus according to a fifth embodiment of the invention, in which FIG. 5a shows the elasticated bands in their non-extended configuration and FIG. 5b shows the elasticated bands in their extended configuration;

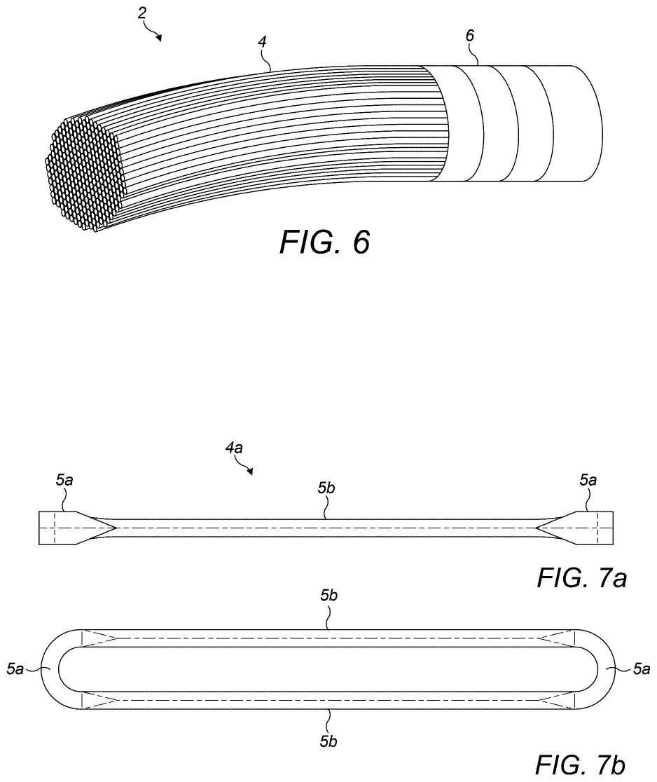

FIG. 6 shows a perspective view of an elasticated band for use in a wave energy apparatus according to the invention;

FIGS. 7a and 7b show views of an alternative elasticated band for use in a wave energy apparatus according to the invention;

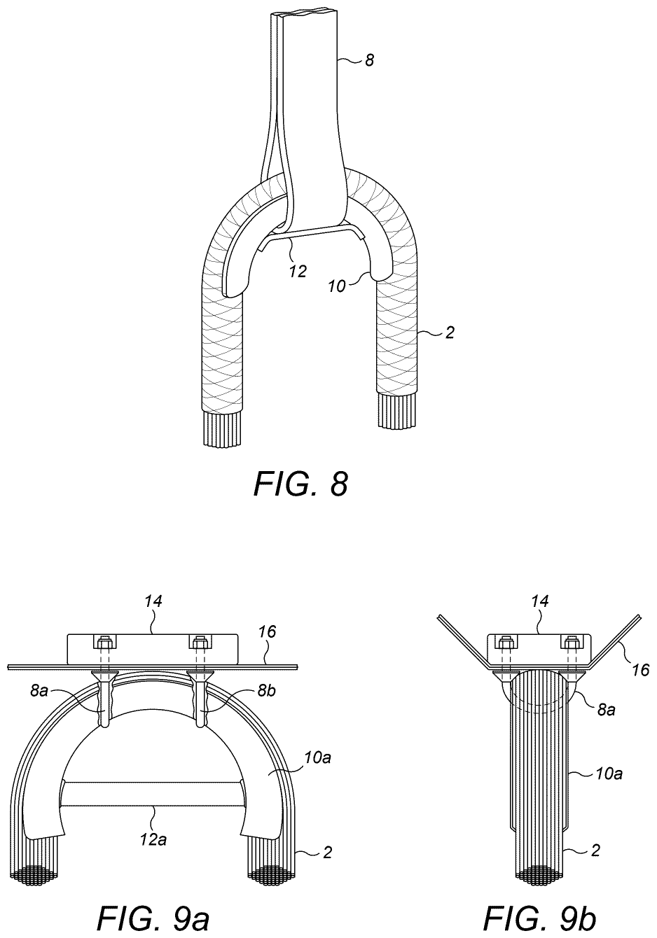

FIG. 8 shows a perspective view of one embodiment of an anchor element that may be used to secure the elasticated band shown in FIG. 6 or 7 to a flexible, non-distensible tube comprising part of a wave energy apparatus according to the invention;

FIGS. 9a and 9b show views of a second embodiment of an anchor element that may be used to secure the elasticated band shown in FIG. 6 or 7 to a flexible, non-distensible tube comprising part of a wave energy apparatus according to the invention;

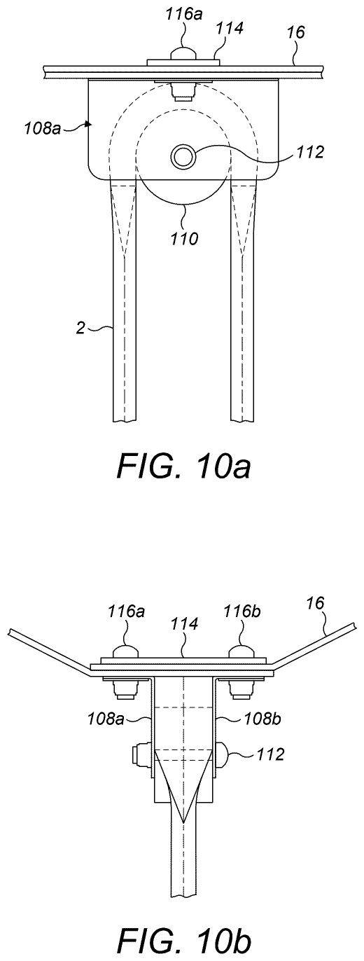

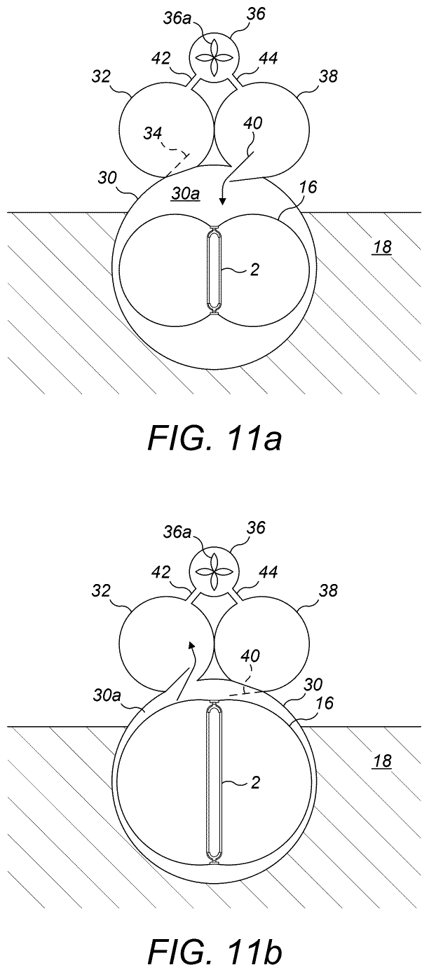

FIGS. 10a and 10b show views of a third embodiment of an anchor element that may be used to secure the elasticated band shown in FIG. 6 or 7 to a flexible, non-distensible tube comprising part of a wave energy apparatus according to the invention;

FIGS. 11a and 11b show a cross section through a first embodiment of an apparatus including the wave energy apparatus shown in FIGS. 1a and 1b, and a power take off apparatus; and

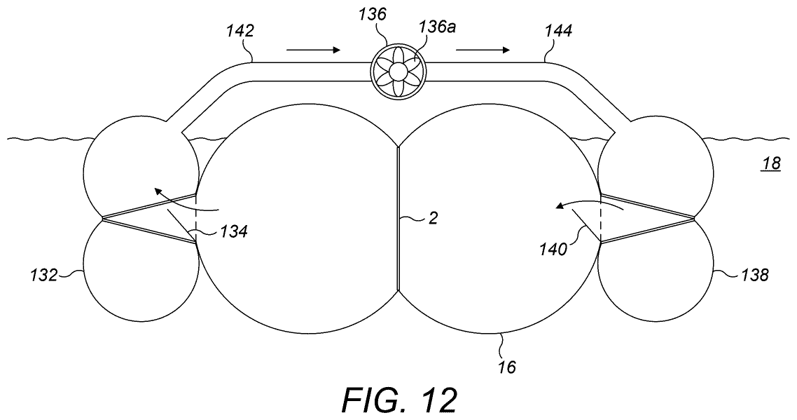

FIG. 12 shows a cross section through a second embodiment of an apparatus including the wave energy apparatus shown in FIGS. 1a and 1b, and an alternative power take off apparatus.

For the avoidance of doubt, the skilled person will appreciate that in this specification, the terms “up”, “down”, “front”, “rear”, “upper”, “lower”, “width”, etc. refer to the orientation of the components as found in the example when installed for normal use as shown in the Figures.

As shown in FIGS. 1a, 1b, 2a, 2b, 3a, 3b, 4a, 4b, 5a and 5b, an elasticated band 2 is connected to a portion of a flexible, non-distensible tube 16, 16a, 16b, 16c, 16d and is secured to the tube 16, 16a, 16b, 16c, 16d via an anchor arrangement comprising an anchor plate 14 arranged on an outer surface of the tube 16, 16a, 16b, 16c, 16d and a saddle element 10 connected to the anchor plate 14 and arranged on an inner surface of the tube 16, 16a, 16b, 16c, 16d.

FIGS. 1a and 1b show an embodiment in which each elasticated band 2 includes two opposed anchor elements, where the anchor elements are secured to opposing portions of the tube 16. The tube 16 is formed from a reinforced rubber-coated fabric, which are well known in the art of marine fabrics. The tube is substantially non-extensible in a radial direction and permits limited extension in an axial direction.

The cross-sectional area of the tube 16 when the elasticated band 2 is in its non-extended or rest configuration (as shown in FIG. 1a) is 15.4 m².

The apparatus comprising the tube 16 and the elasticated band 2 is located within a body of water 18. When an open end of the tube 16 encounters a wave, a bulge wave is generated within the tube 16 which extends the elasticated band 2 into a configuration shown in FIG. 1b. In this extended configuration of the elasticated band 2, the cross-sectional area of the tube 16 increases to 18.5 m². Once the bulge wave has passed the elasticated band 2, the restorative force exerted by the band 2 urges the tube 16 back into its rest configuration, as shown in FIG. 1a. The energy stored in the elasticated band in its extended configuration is released as it relaxes to its rest configuration.

The tube 16 includes external buoyancy aids (not shown) to maintain it in the desired position relative to the surface of the body of water 18.

A second embodiment of the invention is shown in FIGS. 2a and 2b. As can be seen in these figures, the apparatus includes a tube 16a, which is a similar tube to that shown in FIGS. 1a and 1b. However, in this embodiment, the elasticated band 2 includes three anchor elements as described above arranged in the form of an equilateral triangle. Thus, each anchor element has an angular spacing of 120° from the neighbouring anchor elements. This arrangement provides the tube with three lobes, compared to the two lobes of the embodiment shown in FIGS. 1a and 1b.

In this embodiment, the tube 16a includes buoyancy foam 20 located in one of the lobes in order to maintain it in the desired position relative to the surface of the body of water 18.

In this embodiment, the surface area of the tube 16a in its rest configuration as shown in FIG. 2 a (i.e., when the elasticated band 2 is in its non-extended configuration) is 7.6 m² and the cross-sectional area of the tube 16a in its extended configuration (FIG. 2b) is 11.4 m².

A third embodiment of the invention is shown in FIGS. 3a and 3b. As can be seen in these figures, the apparatus includes a tube 16b, which is a similar tube to that shown in FIGS. 1a and 1b. However, in this embodiment, the elasticated band 2 includes four anchor elements as described above arranged in the form of a square. Thus, each anchor element has an angular spacing of 90° from the neighbouring anchor elements. This arrangement provides the tube with four lobes, compared to the two lobes of the embodiment shown in FIGS. 1a and 1b.

In this embodiment, the tube 16b also includes buoyancy foam 20 located in one of the lobes in order to maintain it in the desired position relative to the surface of the body of water 18.

In this embodiment, the surface area of the tube 16b in its rest configuration as shown in FIG. 3a (i.e., when the elasticated band 2 is in its non-extended configuration) is 9.5 m² and the cross-sectional area of the tube 16b in its extended configuration (FIG. 3b) is 15.2 m².

A fourth embodiment of the invention is shown in FIGS. 4a and 4b. In this embodiment, two separate elasticated bands 2 are provided, wherein each elasticated band includes two opposed anchor elements as described above and the two elasticated bands 2 are arranged in a parallel, spaced apart relationship within a tube 16c.

In this embodiment, the surface area of the tube 16c in its extended configuration as shown in FIG. 4b (i.e., when the elasticated bands 2 are both in their extended configuration) is 46% greater than the cross-sectional area of the tube 16c in its non-extended configuration (FIG. 4a).

In this embodiment, the tube 16c includes external buoyancy aids (not shown) to maintain it in the desired position relative to the surface of the body of water 18.

A fifth embodiment of the invention is shown in FIGS. 5a and 5b. In this embodiment, two separate elasticated bands 2 are again provided, wherein each elasticated band includes two opposed anchor elements. However, in this embodiment, the two elasticated bands are arranged in a cruciform relationship within a tube 16d. This arrangement provides a tube which defines four lobes in its rest configuration as shown in FIG. 5a.

In this embodiment, the surface area of the tube 16d in its extended configuration as shown in FIG. 5b (i.e., when the elasticated bands 2 are both in their extended configuration) is 59% greater than the cross-sectional area of the tube 16d in its non-extended configuration (FIG. 5a).

In this embodiment, the tube 16d includes buoyancy foam 20 located in one of the lobes in order to maintain it in the desired position relative to the surface of the body of water 18.

The skilled person will appreciate that the energy imparted to the elasticated bands 2 in each of the foregoing embodiments by a bulge wave passing along the tube may be captured by any known power take-off apparatus.

FIG. 6 shows an embodiment of the elasticated band 2 which comprises a plurality of elasticated cords 4 which are bound together via a helical binding 6 to form an elasticated band in the form of a continuous loop.

FIGS. 7a and 7b show an alternative embodiment of the elasticated band 2 which comprises a single elasticated member 4a. As shown in FIGS. 7a and 7b, the elasticated member 4a includes anchor portions 5a which have a rectangular cross-sectional shape and connecting portions 5b which connect the anchor portions 5a and which have a circular cross-sectional shape. The elasticated member 4a transitions smoothly from the rectangular cross-sectional shape of the anchor portion 5a to the circular cross-sectional shape of the connecting portion 5b.

FIG. 8 shows a first embodiment of an anchor arrangement for the elasticated band 2. The anchor arrangement comprises an inelastic strap 8 which forms a loop 8a at its distal end. Secured within the loop 8a is a saddle element 10. An anchor portion of the elasticated band 2 passes through the loop 8a and is engaged with a channel defined by the saddle element 10. A retaining bar 12 secures the saddle element 10 relative to the loop 8a of the strap 8. A proximal end of the strap 8 is connected to the anchor plate 14 (shown in FIGS. 9a and 9b).

FIGS. 9a and 9b show an alternative embodiment of an anchor arrangement. The anchor arrangement comprises a pair of U-shaped rigid clamping members 8a, 8b which clamps a saddle element 10a to the anchor plate 14. As noted in FIGS. 9a and 9b, the clamping members 8a, 8b pass through the tube 16, as the anchor plate is located outside of the tube 16 and the saddle element is located within the tube 16. A retaining bar 12a prevents inward deflection of the saddle element 10a.

FIGS. 10a and 10b show a further alternative embodiment of an anchor arrangement. In these figures, the anchor arrangement is shown in connection with an elasticated band 2 formed from the single elasticated member 4a shown in FIGS. 7a and 7b. In this embodiment, the anchor arrangement comprises a pair of opposed L-shaped plates 108a, 108b, between which is located a cylindrical support element 110. The cylindrical support element 110 is rotatably coupled to the opposed L-shaped plates 108a, 108b via a central pin 112. The tube 16 is sandwiched between the opposed L-shaped plates 108a, 108b and an anchor plate 114 and the anchor plate 114 is secured to the opposed L-shaped plates 108a, 108b via appropriate fixings 116a, 116b, which may be rivets or nuts and bolts, for example. It will be appreciated that the fixings 116a, 116b pass through the tube 16.

FIGS. 11a and 11b show one example of how the energy imparted to the apparatus may be captured.

In this embodiment, the apparatus shown in FIGS. 1a and 1b is located within an outer tube 30. The outer tube 30 also includes an energy harnessing apparatus for capturing useful energy from the bulge waves that pass through the tube 16. The energy harnessing apparatus includes a pair of elongate accumulators 32, 38, one of which 32 is a high pressure accumulator and the other of which is a low pressure accumulator 38. Each of the accumulators 32, 38 is positioned along the along the top of the outer tube 30 and extends the full length of the outer tube 30. The high pressure accumulator 32 is connected to a fluid chamber 30a by means of a chamber outlet valve 34 and the low pressure accumulator 38 is connected to the fluid chamber 30a by means of a chamber inlet valve 40. The chamber outlet valve 34 is a passive pressure difference operated flap valve that allows fluid (such as, for example, air) to pass under relatively high pressure from the fluid chamber 30a into the high pressure accumulator 32, and the chamber inlet valve 40 is also a passive pressure difference operated flap valve that allows the fluid to pass under relatively low pressure from the low pressure accumulator 38 back into the fluid chamber 30a. As shown in FIG. 11a, when the volume of the fluid chamber 30a is increased after the passage of a bulge wave, the fluid pressure in the fluid chamber 30a drops below that in the low pressure accumulator 38 and the inlet valve 40 opens inwards to the fluid chamber 30 to allow a flow of fluid to pass from the low pressure accumulator 38 into the fluid chamber 30a. As shown in FIG. 11b, when the volume of the fluid chamber 30a is decreased during passage of a bulge wave, the fluid pressure in the fluid chamber 30a increases above the fluid pressure in the high pressure accumulator 32, and the outlet valve 34 opens inwards to the high pressure accumulator 32 to allow a flow of fluid to pass from the fluid chamber 30a into the high pressure accumulator 32.

The energy harnessing apparatus also includes at least one turbine/generator 36a located within a housing 36 disposed between the accumulators 32, 38 and fluidly connected thereto. For convenience, the turbine/generator 36a and its housing 36 are shown schematically above and between the accumulators 32, 38. The turbine/generator 36a may, however, be positioned in a more convenient location, for example inside a mooring structure to which the outer tube 30 is secured. It is then only necessary to run connecting hoses 42, 44 between the accumulators 32, 38 and the turbine/generator housing 36.

The difference in fluid pressure between the high and low pressure accumulators 32, 38 can then be used to drive the turbine/generator 36a to generate electricity. Conventional control and conversion electronics (not shown) can then be used to convert the generated electrical energy to the correct frequency and voltage for onward transmission to the electrical distribution grid or to an electrical energy storage apparatus.

It will be appreciated that there are very significant advantages in using air as the working fluid, instead or water, in the power take-off. Pressure losses in ducting are proportional to the fluid density, and thus reduce by a factor 500 (the water/air density ratio at typical air pressures). It therefore becomes feasible to have the plurality of power take-offs along the device, interconnected by ducting, as described above. This may be considered to be a “distributed power take-off”. As compared with the wave power device disclosed in WO 2007/088325A1 , a distributed power take-off permits the device to tap off the energy in the bulge wave instead of allowing the bulge wave to grow in power until this reaches a power take off at a downstream end of the apparatus. In other words, the invention provides the ability for the outer tubular body to shed power in higher sea states. Such a distributed power take-off therefore protects the outer tube from fatigue, by limiting pressures, and protects the whole apparatus. The tube is therefore considerably cheaper to manufacture.

An alternative power take-off arrangement is shown in FIG. 12. In this embodiment, the apparatus shown in FIGS. 1a and 1b has coupled directly to it the power take-off arrangement. As with the embodiment shown in FIGS. 11a and 11b, the energy harnessing apparatus includes a pair of elongate accumulators 132, 138, one of which 132 is a high pressure accumulator and the other of which is a low pressure accumulator 138. Each of the accumulators 132, 138 is positioned along opposite sides of the tube 16 and extends the full length of the tube. The high pressure accumulator 132 is connected to the interior of the tube 16 by means of a tube outlet valve 134 and the low pressure accumulator 138 is connected to the interior of the tube 16 by means of a tube inlet valve 140. The chamber outlet valve 134 is a passive pressure difference operated flap valve that allows water to pass under relatively high pressure from the interior of the tube 16 into the high pressure accumulator 132, and the chamber inlet valve 140 is also a passive pressure difference operated flap valve that allows the water to pass under relatively low pressure from the low pressure accumulator 138 back into the interior of the tube 16. It will be appreciated that when the volume of the water within the tube 16 decreases after the passage of a bulge wave, the water pressure within the tube 16 drops below that in the low pressure accumulator 138 and the tube inlet valve 140 opens inwards into the tube 16 to allow a flow of the water to pass from the low pressure accumulator 138 into the tube 16. Additionally, when the volume of the water within the tube 16 increases during passage of a bulge wave, the water pressure in the tube 16 increases above the pressure in the high pressure accumulator 132, and the tube outlet valve 134 opens inwards into the high pressure accumulator 132 to allow a flow the water to pass from the interior of the tube 16 into the high pressure accumulator 132.

The energy harnessing apparatus also includes at least one turbine/generator 136a located within a housing 136 disposed between the accumulators 132, 138 and fluidly connected thereto. For convenience, the turbine/generator 136a and its housing 136 are shown schematically above and between the accumulators 132, 138. The turbine/generator 136a may, however, be positioned in a more convenient location, for example inside a mooring structure to which the tube 16 is secured. It is then only necessary to run connecting hoses 142, 144 between the accumulators 132, 138 and the turbine/generator housing 136.

The difference in water pressure between the high and low pressure accumulators 132, 138 can then be used to drive the turbine/generator 136a to generate electricity. Conventional control and conversion electronics (not shown) can then be used to convert the generated electrical energy to the correct frequency and voltage for onward transmission to the electrical distribution grid or to an electrical energy storage apparatus.

1. A wave energy apparatus for extracting energy from waves generated by a body of water, the apparatus including an elongate flexible tubular body, which defines a channel therein having a longitudinal axis, and a plurality of resiliently deformable elements disposed along the tubular body; wherein the elongate flexible tubular body is inextensible in a radial direction; the elongate flexible tube is open at each end; each resiliently deformable element is axially spaced from the adjacent resiliently deformable elements; each resiliently deformable element is secured to the tubular body at two or more anchor portions, wherein the anchor portions for each resiliently deformable element are circumferentially spaced from each other; each of the resiliently deformable elements has a non-extended configuration in which the respective anchor portions of the tubular body are spaced from the longitudinal axis of the channel by a first spacing, and an extended configuration in which the anchor portions of the tubular body are displaced radially outwards and are spaced from the longitudinal axis of the channel by a second spacing, wherein the second spacing is greater than the first spacing; and wherein the cross-sectional area of the tubular body when the resiliently deformable elements are in their extended configuration is greater than the cross-sectional area of the tubular body when the resiliently deformable elements are in their non-extended configuration.

2. A wave energy apparatus according to claim 1, wherein anchor portions for each resiliently deformable element are equally spaced around the circumference of the tubular body.

3. A wave energy apparatus according to claim 1, wherein there are two, three, four or five anchor portions for each resiliently deformable element.

4. A wave energy apparatus according to claim 1, wherein each resiliently deformable element includes one or more resiliently deformable cords or bands.

5. A wave energy apparatus according to claim 4, wherein each resiliently deformable element includes one or two resiliently deformable cords or bands.

6. A wave energy apparatus according to claim 1, wherein each resiliently deformable element comprises an elastic cord.

7. A wave energy apparatus according to claim 6, wherein the elastic cord defines opposed ends and each opposed end is secured to a respective anchor portion defined by the tubular body.

8. A wave energy apparatus according to claim 7, wherein each end of the elastic cord is flared outwards and is bonded or welded to the respective anchor portion.

9. A wave energy apparatus according to claim 1, wherein each resiliently deformable element includes a continuous loop of elastic material; the respective anchor portions each include an anchor element, wherein the anchor elements are secured to the anchor portions of the tubular body and the continuous loop of elastic material is coupled to each of the respective anchor elements.

10. A wave energy apparatus according to claim 9, wherein the anchor elements each define an engagement portion which engages a portion of the continuous loop of elastic material.

11. A wave energy apparatus according to claim 10, wherein the engagement portion is cylindrical or saddle-shaped.

12. A wave energy apparatus according to claim 6, wherein each cord or loop of elastic material has a substantially circular cross section.

13. A wave energy apparatus according to claim 6, wherein each cord or loop of elastic material is formed from a plurality of separate elastic filaments which are secured together.

14. A wave energy apparatus according to claim 6, wherein each cord or loop of elastic material is formed from a single component of an elastic material.

15. A wave energy apparatus according to claim 1, wherein the elongate flexible tubular body is formed from a coated fabric.

16. A wave energy apparatus according to claim 1, wherein the apparatus further includes a buoyancy member.

17. A wave energy apparatus according to claim 16, wherein the buoyancy member is located within the elongate flexible tubular body.

18. A wave energy apparatus according to claim 1, wherein the apparatus further includes an energy converter which converts the energy extracted by the change in the cross-sectional area of the elongate flexible tubular body into electrical energy.

19. A wave energy apparatus according to claim 18, wherein a fluid is compressed or pressurised by the increase or decrease in the cross-sectional area of the elongate flexible tubular body, and the compressed or pressurised fluid drives the energy converter.

20. A wave energy apparatus according to claim 19, wherein the elongate flexible tubular body is located within an outer, non-distensible tube, wherein the outer tube defines one or more fluid channels outside of the elongate flexible tubular body and the or each fluid channels are compressed when the cross-sectional area of tubular body increases.

21. A wave energy apparatus according to claim 19, wherein the energy converter is coupled to the elongate flexible tubular body and the water within the tube is pressurised as a result of a bulge wave passing down the tube, and the pressurised water drives the energy converter.
